(19) United States
(12) Patent Application Publication
(10) Pub. No.: US 2026/0267161 A1
(43) Pub. Date: Sep. 10, 2026

(54) NOSE PAD FOR EYEGLASSES AND RELATED EYEGLASSES

(71) Applicant: LUXOTTICA S.R.L., AGORDO (IT)

(72) Inventors: Andrea DA RIN DE NICOLO', BELLUNO (IT); Alessandro ZANELLA, CREAZZO (IT)

(21) Appl. No.: 18/875,594

(22) PCT Filed: May 23, 2023
(86) PCT No.: PCT/EP2023/063764

§ 371 Date: Dec. 16, 2024

(30) Foreign Application Priority Data
Jun. 17, 2022 (IT) 102022000012848

(51) Int. Cl. G02C 5/12

(52) U.S. Cl. CPC G02C 5/122

(57) ABSTRACT

A nose pad for eyeglasses, comprising an element provided with at least one pair of arms and configured to be fixed to a frame of a pair of eyeglasses, each one of the arms being provided with rotation elements, at least one pair of accommodation elements being provided which are adapted to be engaged by said rotation elements for an independent adjustment of each one of said accommodation elements around said rotation elements.

The present invention relates to a nose pad for eyeglasses and a related pair of eyeglasses. More specifically, the invention relates to a nose pad for eyeglasses that is more comfortable for the user with respect to known solutions.

As is known, eyeglasses are worn by the user by resting them on his or her nose by means of a pair of nose pads which are arranged proximate to each one of the lenses, to the rear of them.

The nose pads are generally made with a pair of wings that can have a certain mobility to adapt to the side walls of the nose of each user.

Obviously, every user's nose is different and therefore the adaptation of a pair of eyeglasses can be problematic in that the poor mobility of the respective wings may not be sufficient to make wearing the eyeglasses comfortable for each existing type of nose.

Furthermore, conventional wings, even if they do have a slight mobility, are not however capable of adapting to the different existing shapes of noses, and all this translates to discomfort for the user, who perceives distinctly that if he or she wears these eyeglasses they will not be integrated in his or her face.

The aim of the present invention is to provide a nose pad for eyeglasses that makes it possible to be totally adjustable so as to be adaptable to any type of nose of the user who wears the eyeglasses.

Within this aim, an object of the present invention is to provide a nose pad for eyeglasses that is extremely comfortable for the user who wears the eyeglasses, and which therefore makes it possible for the user substantially not to perceive the nose pad resting on his or her nose.

Another object of the present invention is to provide a nose pad for eyeglasses that allow a fit that is comfortable and at the same time stable of the eyeglasses themselves.

Another object of the present invention is to provide a nose pad for eyeglasses and a related pair of eyeglasses that are highly reliable, easily and practically implemented and of low cost.

This aim and these and other objects which will become better apparent hereinafter are achieved by a nose pad for eyeglasses, characterized in that it comprises an element provided with at least one pair of arms and configured to be fixed to a frame of a pair of eyeglasses, each one of said arms being provided with rotation means, at least one pair of accommodation means being provided which are adapted to be engaged by said rotation means for an independent adjustment of each one of said accommodation means around said rotation means.

Further characteristics and advantages of the invention will become better apparent from the description of preferred, but not exclusive, embodiments of the nose pad for eyeglasses according to the present invention, which are illustrated by way of non-limiting example in the accompanying drawings wherein:

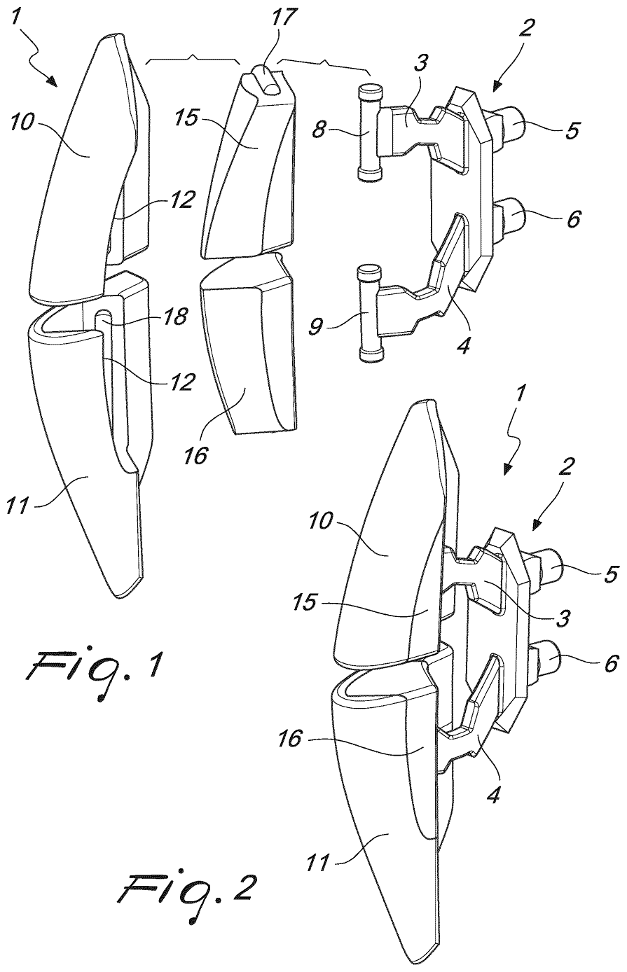

FIG. 1 is an exploded perspective view of the nose pad according to the present invention;

FIG. 2 is a perspective view of the nose pad according to the present invention in the assembled condition;

FIG. 3 is an additional exploded perspective view of the nose pad according to the present invention;

FIG. 4 is a plan view of the nose pad according to the present invention;

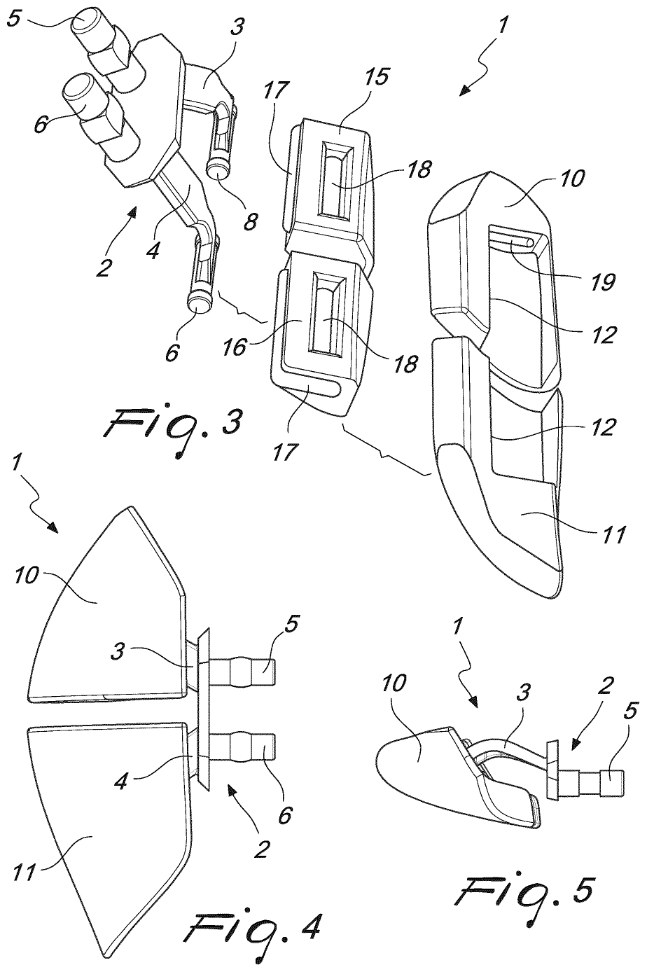

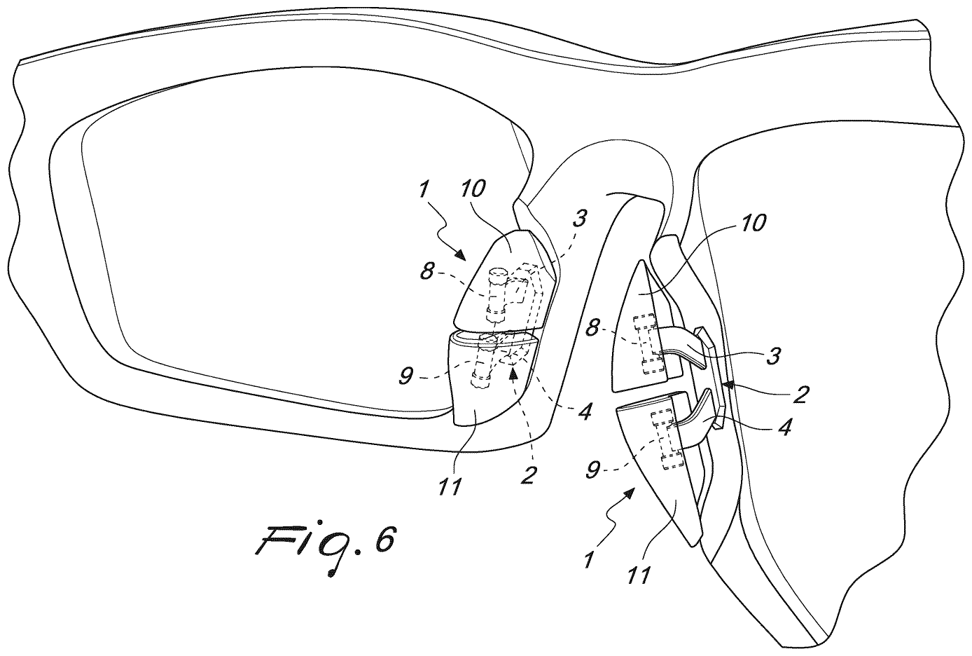

FIG. 5 is a side view of the nose pad according to the present invention;

FIG. 6 is a perspective view of the nose pad according to the present invention mounted on a pair of eyeglasses;

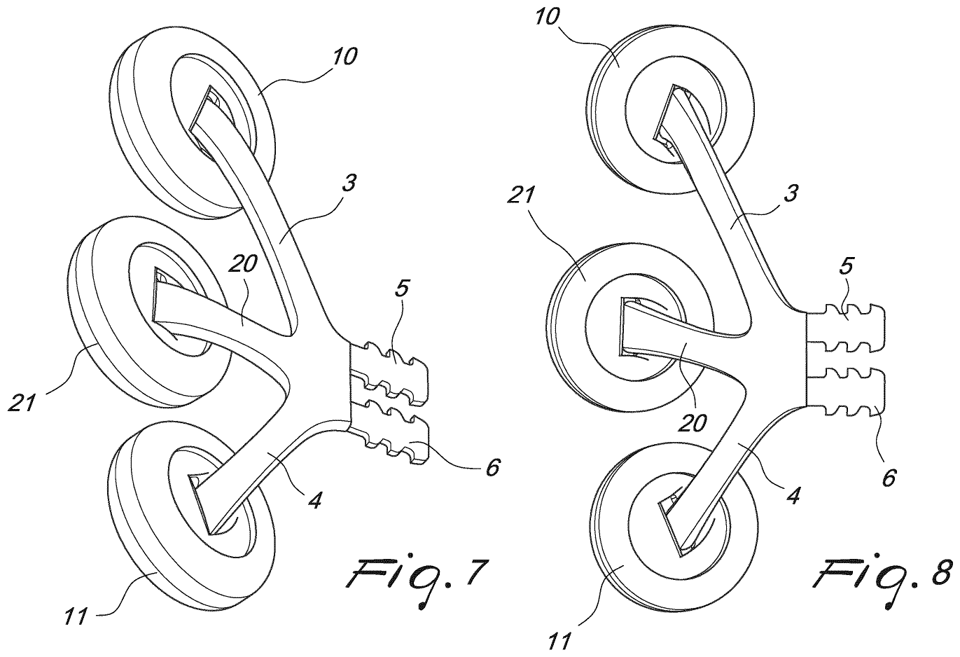

FIG. 7 is a perspective view of a second embodiment of a component of the nose pad according to the present invention;

FIG. 8 is an additional perspective view of the second embodiment of a component of the nose pad according to the present invention.

With reference to the figures, the nose pad for eyeglasses according to the present invention is generally designated by the reference numeral 1.

The nose pad for eyeglasses is composed of at least two portions which are arranged at each lens, which in conjunction make it possible to rest the eyeglasses on the nose of the user.

Below, therefore, reference will be made to a portion of the nose pad, arranged at a lens, in so doing giving to understand that what is said for one portion of the nose pad can be replicated exactly for the other portion, arranged at the other lens.

The nose pad for eyeglasses according to the present invention comprises therefore a first element 2 provided with at least one pair of arms 3 and 4 and at least one pair of respective fixing means, such as for example pins 5 and 6 which are adapted to make it possible to fix the element 2 in a portion of frame 7 of the eyeglasses according to the present invention.

In substance, therefore, the element 2 is adapted to be mated with the frame 7, with the arms 3 and 4 protruding rearward from the frame 7, toward the face of the user.

The arms 3 and 4 are conveniently each provided with rotation means which are conveniently provided by connecting elements 8 and 9, and each connecting element is arranged substantially perpendicular to the respective arm 3, 4.

The connecting elements 8 and 9 are substantially cylindrical, and their function will be explained in detail below.

The substantially cylindrical connecting elements 8 and 9 can also be substituted by substantially spherical connecting elements.

The arms 3 and 4 are conveniently curved so as to bring the connecting elements 8 and 9 toward the nose of the user who is to wear the eyeglasses.

The nose pad according to the invention further comprises accommodation means which are adapted to be engaged by the rotation means 8, 9, for an independent adjustment of each one of the accommodation means around the rotation means 8, 9. The accommodation means are configured to rest on the nose of the user.

Conveniently the accommodation means comprise retention means 15, 16 which are adapted to receive the connecting elements 8, 9. Each one of the retention means is further provided with a cavity 18 that allows it to receive the connecting elements 8, 9, in so doing allowing a rotation of such connecting elements within the cavities 18.

In this embodiment the retention means 15, 16 also act as wings and are therefore configured to rest on the nose of the user, and they can be adjusted independently of each other, in that the rotation of one of the retention means is done independently of the rotation of the adjacent one, in order to allow an optimal fit of the eyeglasses on the nose of the user.

The accommodation means can also comprise, in addition to the retention means 15, 16, at least one pair of wings 10 and 11, which are configured to rest on the nose of the user (in place of the retention means 15, 16). Each one of the wings 10 and 11 comprises a recessed seat 12 which allows the accommodation, for example by interlocking, of the retention means 15, 16 of the connecting elements 8 and 9. The retention means 15, 16 are provided with a perimetric raised portion 17 which is adapted to be coupled in undercuts 19 defined in the recessed seats 12 of the wings 10, 11.

The retention means 15, 16 can be accommodated in the respective seats 12 defined in the wings by way of shape mating.

In substance, the wings 10, 11 are adapted to receive the retention means 15, 16, for example by way of interlocking, and the retention means 15, 16 in turn receive the connecting elements 8, 9 of the arms 3, 4 in their seats 18.

In this manner, the wings 10, 11 can rotate about the connecting elements 8, 9 of the element 2 so as to be adjustable independently of each other, in that the rotation of one wing is performed independently of the rotation of the adjacent wing, in order to allow an optimal fit of the eyeglasses on the nose of the user.

The fact of having a differentiated rotation between the wings 10 and 11 makes it possible to adapt to the outer shape of substantially any type of nose that the user could have, in so doing also enabling a very stable fit of the eyeglasses on the nose of the user.

Conveniently, the wings 10, 11, like the retention means 15, 16, are made of rubber for reasons of comfort, or another material suitable for the provision of wings for eyeglasses (e.g. gel or plastic).

The possibility of the wings 10, 11 (or of the retention means 15, 16) to rotate around the connecting elements 8 and 9, which are therefore fixed since they are arranged at the ends of the arms 3 and 4 which are coupled via the pins 5 and 6 to the frame of the eyeglasses, give the nose pad, as mentioned, the substantially infinite possibility of adjusting one wing (or one of the retention means) in rotation independently from the other wing (or the other one of the retention means).

Advantageously, the retention means 15, 16 are constituted by a kind of blocks that are adapted to be coupled via interlocking in the seats 12 of the wings 10, 11.

In an alternative embodiment, the element 2 can be provided with three arms 3, 4 and 20 and therefore with three wings 10, 11 and 21, as shown in FIGS. 7 and 8. What has been explained for the embodiment with two arms is therefore meant to be replicable for the embodiment with three arms as well.

In practice it has been found that the nose pad according to the present invention fully achieves the set aim and objects, in that it makes it possible to have a totally comfortable and stable fit of the eyeglasses on any type of nose and therefore it is adaptable substantially to any user.

Furthermore, the nose pad according to the present invention makes it absolutely simple to substitute the wings if these should become worn out or deteriorate, in that it is sufficient to uncouple the wings (or the retention means) from the respective cylindrical pins arranged at the ends of the arms of the element that is fixed to the frame of the eyeglasses.

The invention also relates to a pair of eyeglasses that is provided with the nose pad described above.

The nose pad, thus conceived, is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

The disclosures in Italian Patent Application No. 102022000012848 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-16. (canceled)

17. A nose pad for eyeglasses, comprising an element provided with at least one pair of arms and configured to be fixed to a frame of a pair of eyeglasses, each one of said arms being provided with rotation means, at least one pair of accommodation means being provided which are adapted to be engaged by said rotation means for an independent adjustment of each one of said accommodation means around said rotation means.

18. The nose pad according to claim 17, wherein said accommodation means comprise at least one pair of retention means which are adapted to be engaged by said rotation means, said retention means being configured to rest on the nose of the user.

19. The nose pad according to claim 17, wherein said accommodation means comprise at least one pair of retention means which are adapted to be engaged by said rotation means, and at least one pair of wings which are configured to receive said retention means, said wings being configured to rest on the nose of the user.

20. The nose pad according to claim 17, wherein said rotation means comprise a pair of cylindrical connecting elements which are each arranged at an end of one of said arms, said cylindrical connecting elements being adapted to engage in said retention means.

21. The nose pad according to claim 17, wherein said rotation means comprise a pair of substantially spherical connecting elements which are each arranged at an end of one of said arms, said substantially spherical connecting elements being adapted to engage in said retention means.

22. The nose pad according to claim 19, wherein said retention means are adapted to be accommodated in seats defined in said wings.

23. The nose pad according to claim 22, wherein said retention means are adapted to be accommodated in said seats defined in said wings by way of shape mating.

24. The nose pad according to claim 17, wherein each of said retention means comprises a cavity which is adapted to be engaged by a respective connecting element.

25. The nose pad according to claim 22, wherein said retention means comprise a perimetric raised portion adapted to engage in an undercut defined in the seats of said wings.

26. The nose pad according to claim 17, wherein said element provided with said pair of arms is further provided with at least one pair of fixing means which are adapted to allow stable coupling with said frame.

27. The nose pad according to claim 17, wherein said arms are three in number.

28. The nose pad according to claim 24, wherein said cavities of said retention means which are adapted to accommodate said cylindrical connecting elements are substantially rectangular in shape.

29. The nose pad according to claim 19, wherein said retention means and said wings are made of rubber or plastic or gel or silicone.

30. The nose pad according to claim 20, wherein said arms which end with said connecting elements are curved so as to be directed toward the nose of the user when the user wears eyeglasses provided with said nose pad.

31. The nose pad according to claim 19, wherein said wings are configured to be uncoupled from respective cylindrical connecting elements arranged at the ends of the arms of the element that is fixed to the frame of the eyeglasses.

32. Eyeglasses, comprising a pair of nose pads according to claim 17.
